(19) United States
(12) Patent Application Publication
(10) Pub. No.: US 2009/0135195 A1
(43) Pub. Date: May 28, 2009

(54) Liquid Crystal Display and Method for Adjusting Backlight Brightness Thereof

(76) Inventors: Chin-Lung CHEN, Hsinchu (TW); Chun-Hsien Lin, Hsin-chu (TW); Po-Chin Huang, Hsin-Chu (TW)

Correspondence Address: HDLS Patent & Trademark Services, P.O. BOX 220746, CHANTILLY, VA, 20153-0746, US

(21) Appl. No.: 12/180,236

(22) Filed: Jul. 25, 2008

(30) Foreign Application Priority Data
Nov. 26, 2007 (TW) 096144769

(51) Int. Cl. G09G 3/36

(52) U.S. Cl. 345/589; 349/102

(57) ABSTRACT

A liquid crystal display includes a scaler module, a field-programmable gate array (FPGA) module, a buffer, a backlight module and a LCD module. The FPGA module includes a regional peak detector, a backlight control unit and a pixel value control unit. The regional peak detector is configured for detecting a maximum pixel value of each image region of each image. The backlight control unit is configured for selectively adjusting the backlight brightness of one or more image regions of each image. The pixel value control unit is configured for adjusting pixel values of the one or more image regions of each image by shifting binary pixel values to compensate for the influence of backlight adjustment. A method for adjusting backlight brightness of a liquid crystal display is also provided.

### BACKGROUND

1. Field of Invention

The present invention relates to liquid crystal display (LCD) technologies, and more particularly to a LCD and a method for adjusting backlight brightness of the LCD.

2. Description of Related Art

A conventional liquid crystal display (LCD) includes a LCD module, a backlight module and a scaler module. The scaler module sends a backlight brightness parameter for an image to be displayed to the backlight module so that the backlight module is capable of generating backlight of certain brightness according to the brightness parameter. In the meanwhile, the scaler module sends multiple pixel values of the image to the LCD module. The multiple pixel values respectively control the orientations of the liquid crystal molecules at each pixel in the LCD module so as to control the amount of backlight generated by the backlight module passing through each pixel and control the pixel brightness of each pixel.

However, the brightness parameter that the scaler module sends to the backlight module is not time-variant. At the most, a user is free to set the brightness parameter to a preferred value. As a result, when a dark image is being displayed, the backlight generated by the backlight module may not be effectively blocked by the liquid crystal because of the physical limit on the degree of rotation of the liquid crystal molecules and thus the contrast ratio of the image may be reduced.

### BRIEF SUMMARY

Accordingly, the present invention is to provide a LCD that is capable of dynamically adjusting the backlight brightness according to images to be displayed so as to improve the contrast ratio of the displayed images.

The present invention is to provide a method for adjusting backlight brightness of a LCD with which the backlight brightness is dynamically adjusted according to images to be displayed so as to improve the contrast ratio of the displayed images.

An embodiment of the present invention provides a LCD including a scaler module, a FPGA (field-programmable gate array) module, a buffer, a backlight module and a LCD module. The scaler module is configured for providing multiple images. The multiple images include a first image. The first image includes at least an image region having multiple pixel values and a backlight brightness parameter. The FPGA module includes a regional peak detector, a backlight control unit and a pixel value control unit. The regional peak detector detects the maximum pixel value in the multiple pixel values of the image region and sends this value to the buffer. The backlight control unit is configured for receiving the backlight brightness parameter of the image region, retrieving the maximum pixel value from the buffer and according to the maximum pixel value selectively adjusting the backlight brightness parameter of the whole image region. The pixel value control unit is configured for receiving the multiple pixel values of the image region, retrieving the maximum pixel value from the buffer and according to this maximum pixel value selectively shifting the binary bits of each pixel value of the image region by at least one bit so as to adjust these pixel values. The backlight module includes at least a backlight source and is configured for receiving the adjusted backlight brightness parameter from the backlight control unit and controlling the backlight brightness of the backlight source according to the brightness parameter. The LCD module includes multiple pixels with liquid crystal. The LCD module is configured for receiving the adjusted multiple pixel values from the pixel value control unit and according to these pixel values controlling the orientation of the liquid crystal molecules at the multiple pixels of the LCD module.

In a preferred embodiment of the present invention, the pixel value control unit selectively adjusts each pixel value in the image region by using a look-up table.

Another embodiment of the present invention provides a method for adjusting backlight brightness of a liquid crystal display. The method includes the following steps:
providing multiple images, the multiple images including a first image, the first image including at least an image region having multiple pixel values and a backlight brightness parameter;
detecting the maximum pixel value in the multiple pixel values of the image region, according to the maximum pixel value, selectively adjusting the backlight brightness parameter of the whole image region;
according to the maximum pixel value selectively shifting the binary bits of each pixel value of the image region by at least one bit so as to adjust each pixel value in the image region and compensate the influence of the adjustment of the backlight brightness parameter of the image region on the displayed brightness of the pixels.

In another preferred embodiment of the present invention, each pixel value in the image region is selectively adjusted by using a look-up table.

The embodiments of the present invention use the FPGA module to selectively adjust the backlight brightness of the image region according to a reference value generated by multiple pixel values of the image region of the images to be displayed (such as the maximum pixel value). In addition, by shifting the binary bit representing each pixel value of the image region by at least a bit, each pixel value of the image region is adjusted to compensate the adjustment of the backlight brightness. Hence, the problem of light leaking in the backlight module and the resulted reduced contrast ratio in displaying dark images due to the physical limit on the rotation of liquid crystal molecules is overcome. The preferred embodiments of the present invention selectively adjusts the pixel values of the image region by using a look-up table so as to improve the speed of processing the pixel values of the image region and improve the overall performance of the LCD.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a liquid crystal display according to an embodiment of the present invention.

FIG. 2 is process flow diagram illustrating a process of detecting the maximum pixel value of multiple pixel values in an image region according to another embodiment of the present invention.

### DETAILED DESCRIPTION OF THE PREFERRED EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

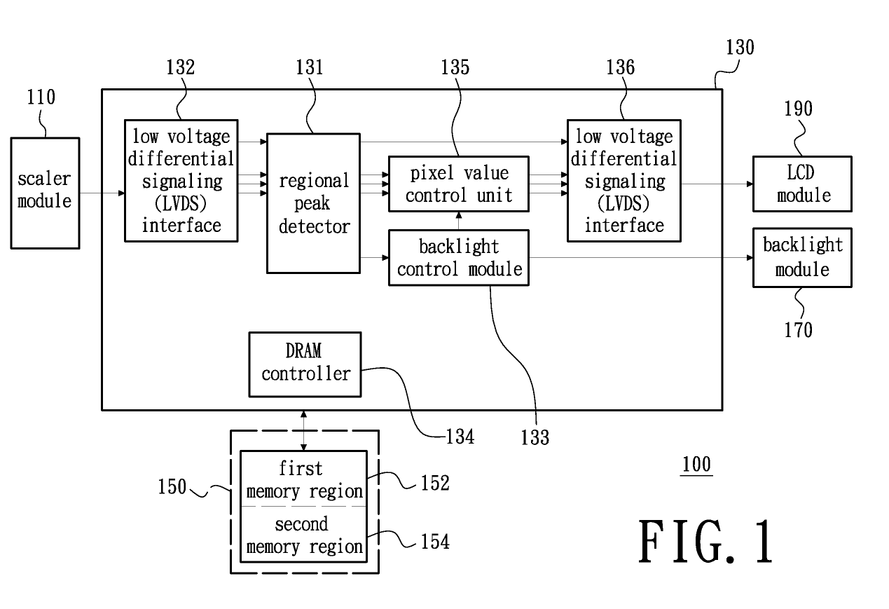

Referring to FIG. 1, a liquid crystal display (LCD) 100 according to an embodiment of the present invention is provided. The LCD 100 includes a scaler module 110, a FPGA module 130, a buffer 150, a backlight module 170 and a LCD module 190.

The scaler module 110 is configured for providing multiple images to be displayed. According to the quantity of backlight sources in the backlight module 170, each image is divided into multiple image regions corresponding to the multiple backlight sources. Each image region has multiple pixel values and a backlight brightness parameter corresponding to this image region.

The FPGA module 130 includes a regional peak detector 131, two low voltage differential signaling (LVDS) interfaces 132 and 136, a backlight control unit 133, a dynamic random access memory (DRAM) controller 134 and a pixel value control unit 135.

In this embodiment of the present invention, the FPGA module 130 is electrically connected respectively with the scaler module 110 and the LCD module 190 through the LVDS interfaces 132 and 136. The regional peak detector 131 is electrically connected with the scaler module 110 through the LVDS interface 132. With this configuration, the regional peak detector 131 is capable of detecting all the image regions in each image provided by the scaler module 110 and detecting a maximum pixel value of all the pixel values for each image region. The backlight control module 133 is electrically connected to the regional peak detector 131 so that the backlight control module 133 is capable of receiving a backlight brightness parameter corresponding to all the image regions in each image provided by the scaler module 110. The DRAM controller 134 is configured for saving the maximum pixel value to the buffer 150, which is electrically coupled to the DRAM controller 134, and for reading the maximum pixel values from the buffer 150. The pixel value control unit 135 is electrically coupled with the regional peak detector 131 so as to receive the pixel values of each image provided by the scaler module 110.

For considerations of processing speed, it is desired to read and write maximum pixel values of the multiple pixel values of all image regions in two consecutive images. So the buffer 150 may include a first memory region 152 and a second memory region 154 so as to process reading and writing operations separately. More specifically, during the process of the regional peak detector 131 detecting a first image, the pixels in the first image are divided into a group of pixels that have been detected by the regional peak detector 131 and a group of pixels that have not been detected by the regional peak detector 131. The first memory region 152 is configured for storing the maximum pixel values in the group of pixels that have been detected by the regional peak detector 131. The second memory region 154 is configured for storing the maximum pixel values in all the pixels of this image. It is understood that if the maximum performance is not concerned, however, only one memory is sufficient for storing all the data.

The backlight module 170 has multiple backlight sources that are independently controlled, such as 9×9 backlight sources. The backlight module 170 is configured for receiving the adjusted backlight brightness parameter from the backlight control unit 133 and according to the brightness parameter corresponding to each image region, controlling the brightness of the backlight source corresponding to the image region.

The LCD module 190 including multiple pixels with liquid crystals respectively is configured for receiving the adjusted multiple pixel values of each image region from the pixel value control unit 135 and according to these pixel values controlling the orientation of the liquid crystal molecules at the multiple pixels of each image region of the LCD module so as to control the amount of backlight generated by the backlight sources of the backlight module 170 passing through each pixel.

A method for adjusting backlight brightness of a liquid crystal display is provided according to another embodiment of the present invention. The method basically includes:

(1) Sending an image to be displayed from a scaler module 110 to a regional peak detector 131 through a LVDS interface 132. The image includes multiple image regions, for example 9×9 image regions. Each image region has multiple pixel values and a backlight brightness parameter corresponding to this image region.

(2) Detecting the maximum pixel value in the multiple pixel values by the regional peak detector 131 and storing the detected maximum pixel value to a buffer 150 through a dynamic random access memory (DRAM) controller 134.

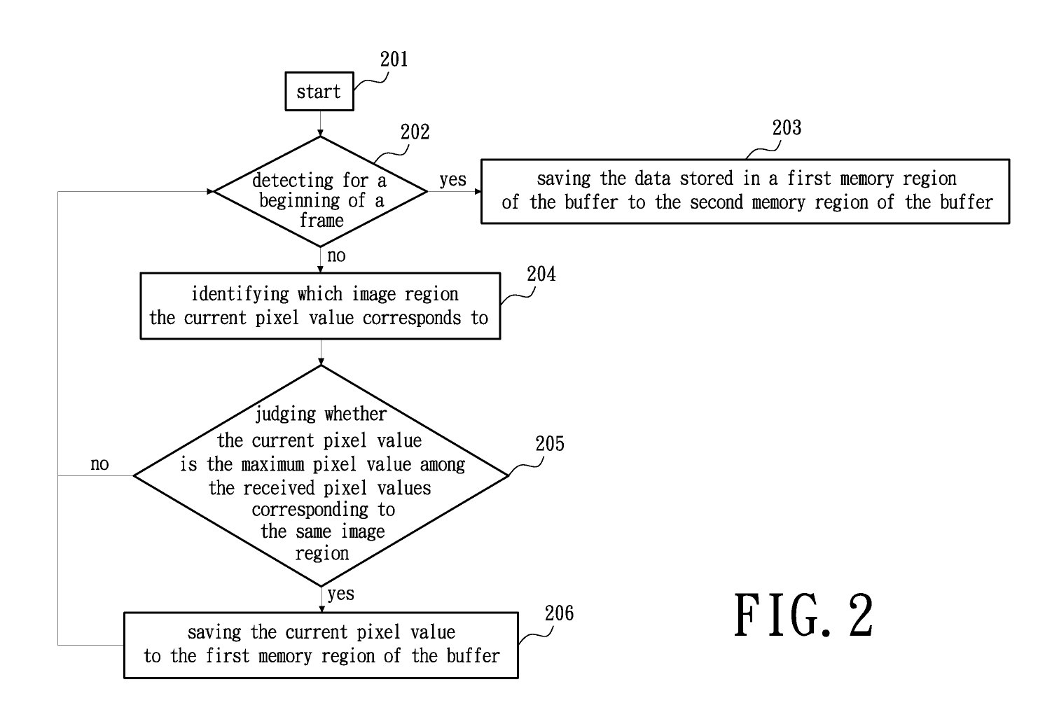

More specially, referring to FIG. 2, the process includes:

Step 201: Starting to detect for the maximum pixel value of each image region of an image.

Step 202: Detecting for a beginning of a frame.

The beginning of a frame is determined by detecting for an impulse signal of vertical synchronization (V-sync).

At a particular time, if a beginning of a frame is detected, step 203 is carried out to save the data stored in a first memory region 152 of the buffer 150 (the maximum pixel values corresponding to each image region of the image) in a second memory region 154. If a beginning of a frame is not detected, the step 204 is carried out to identify which image region the current pixel value corresponds to.

Step 205: Comparing the current pixel value and the other pixel values corresponding to the same image region that have been received. If the current pixel value is the greatest, a step 206 is carried out to save the current pixel value to the first memory region 152. If the current pixel value is not the greatest, the process goes back to the step 202.

After the above steps, the maximum pixel values corresponding to each image region are identified and stored in the first memory region 152. In addition, at appropriate timing, for example when a beginning of a next image frame is detected, these maximum pixel values are stored in the second memory region 154.

(3) By a backlight control unit 133, receiving unadjusted backlight brightness parameters from the regional peak detector 131, reading the maximum pixel values stored in the second memory region 154 of the buffer 150 by the DRAM controller 134, and according to the maximum pixel values selectively lowering the backlight brightness parameters for the image regions that have the maximum pixel values. Then the adjusted backlight brightness parameters are sent to the backlight module 170. By this means, the backlight module 170 is capable of adjusting the brightness of at least a backlight source corresponding to the image region according to the received backlight brightness parameter so as to control the backlight brightness.

(4) A pixel value control unit 135, receiving the multiple pixel values for each image region from the regional peak detector 131, reading the maximum pixel values from the second memory region 154 with the DRAM controller 134 and according to each maximum pixel value selectively adjusts all the pixel values in the image region that has the maximum pixel value. The adjusted pixel values are sent to a LCD module 190. According to the adjusted pixel values, the LCD module 190 controls the orientation of the liquid crystal molecules at all the pixels of each image region of the LCD module so as to control the amount of backlight passing through each pixel and thus the brightness of each pixel. In other words, the adjusted pixel values are used to compensate the influence of the adjustment of the backlight brightness parameters of the image regions on the displayed brightness of the pixels.

Referring to Table 1, a method for selectively adjusting the backlight brightness parameter of the image region and selective adjusting the pixel values of the image region is provided according to a preferred embodiment of the present invention. An eight-bit binary (B7, B6, B5, B4, B3, B2, B1, B0) is used to represent the original pixel value. The adjusted pixel value after being processed by the pixel value control unit 135 is represented by eight-bit binary (b7, b6, b5, b4, b3, b2, b1, b0). X may be 0 or 1, depending on the original value of the maximum pixel value.

TABLE 1

| | | | Ratio of |
|---|---|---|---|
| | Maximum Pixel Value | Change on All Pixel values in Image | Backlight Brightness |
| Option | in Image Region | Region | Parameter Change |
| 1 | 00000000 | Unchanged | 0 |
| 2 | 00000001 | Left shifted by 7 bits and | 1/128 |
| | | b6 = b5 = b4 = b3 = b2 = b1 = b0 = 1 | |
| 3 | 0000001X | Left shifted by 6 bits and | 1/64 |
| | | b5 = b4 = b3 = b2 = b1 = b0 = B0 | |
| 4 | 000001XX | Left shifted by 5 bits and b4 = b2 = b0 = B1, | 1/32 |
| | | b3 = b1 = B0 | |
| 5 | 00001XXX | Left shifted by 4 bits and b3 = b0 = B2, | 1/16 |
| | | b2 = B1, b1 = B0 | |
| 6 | 0001XXXX | Left shifted by 3 bits and b2 = B3, b1 = B2, | 1/8 |
| | | b0 = B1 | |
| 7 | 001XXXXX | Left shifted by 2 bits and b1 = B4, b0 = B3 | 1/4 |
| 8 | 01XXXXXX | Left shifted by 1 bit and b0 = B5 | 1/2 |
| 9 | 1XXXXXXX | Unchanged | 1 |

Referring to Table 1, in this embodiment of the present invention, each backlight source has nine levels of brightness. The backlight module selects a level for a backlight source according to a backlight brightness parameter. For example, when the maximum pixel value of an image region is in the range between option 2 and option 8, the backlight brightness parameter of this image region is reduced by a factor of 2^{N}, wherein N is the number of bits by which the binary backlight brightness parameter is left shifted. When the maximum pixel value of an image region fits the option 1, that is, the binary maximum pixel value is 00000000, the backlight brightness parameter of this image region is set to be zero. In addition, when the maximum pixel value of an image region fits the option 9, that is, the binary maximum pixel value is 1XXXXXXX, the backlight brightness parameter of this image region is set to be unchanged. In other words, according to the maximum pixel value of each image region, the backlight brightness parameter of the image region is selectively adjusted.

Referring to Table 1, when the maximum pixel value of the image region is in the range between option 2 and option 8, according to the maximum pixel value, all the binary pixel values of the image region is left shifted by at least one bit so as to increase these values. In a preferred embodiment, referring to Table. 1, predetermined values are filled to the new bits resulted from the shifting. For example, when the maximum pixel value of an image region is

option 8 in Table 1 is used to modify the pixel values of the image region. In this case, if a pixel value in the image region is originally 00110010, that is the value of B7 to B0 are respectively 0, 0, 1, 1, 0, 0, 1, 0, then according to option 8, this original pixel value should be now left shifted by one bit. The new bit resulted from the shifting, which is the last bit b0 should be substituted by the original B5 (with value 1). Hence, the new pixel value of this pixel has b7 to b0 respectively to be 0, 1, 1, 0, 0, 1, 0, 1, that is, the new pixel value is 01100101. For another example, when the maximum pixel value of an image region is 00001010, option 5 in Table 1 is used to modify the pixel values of the image region. In this case, if a pixel value in the image region is originally 00000101, that is the value of B7 to B0 are respectively 0, 0, 0, 0, 0, 1, 0, 1, then according to option 5, this original pixel value is now left shifted by four bits. The new four bits resulted from the shifting are b3, b2, b1 and b0. The b3 and b0 are substituted by the original B2 (with value 1). The b2 is substituted by the original B1 (with value 0). The b1 is substituted by the original B0 (with value 1). Hence, the new pixel value of this pixel has b7 to b0 respectively to be 0, 1, 0, 1, 1, 0, 1, 1, that is, the new pixel value is 01011011.

When the maximum pixel value of the image region falls into the option 1, that is, the binary maximum pixel value is 00000000, or the option 9, that is, the binary maximum pixel value is 1XXXXXXX, the pixel values in the image region stay unchanged.

As illustrated above, according to the maximum pixel value of each image region of the image the binary pixel values of the image region is selectively shifted by at least one bit. In the preferred embodiment, the pixel values of each image region are changed by using the look-up table.

According to the embodiments of the present invention, it is understood that the maximum pixel values of image regions of the previous frame of image may be used to adjust the backlight brightness parameter and the pixel values of the image regions of the current frame of image. It is also understood that if there is sufficient memory for buffering, the maximum pixel values of some image regions of the current frame of image may be used to adjust the backlight brightness parameter and the pixel values of other image regions of the current frame of image.

It is also understood that although in the above embodiments of the present invention the maximum pixel value of the image region is used as a reference value for adjusting the backlight brightness parameter and the pixel values of the image region, other reference values such as a mean, a mode, or a median of multiple pixel values may be used to serve the same purpose.

The LCD 100 and the method for adjusting backlight brightness of a liquid crystal display provided by the present invention use the FPGA module 130 to selectively adjust the backlight brightness parameter of the image region according to a reference value such as the maximum pixel value of the multiple pixel values of the image region of the images to be displayed, by binary bit shifting, that is, by shifting the binary backlight brightness parameter by at least one bit. In addition, by shifting the binary bit representing each pixel value of the image region by at least a bit, each pixel value of the image region is adjusted to compensate the adjustment of the backlight brightness. Hence, the problem of light leaking in the backlight module and the resulted reduced contrast ratio in displaying dark images due to the physical limit on the rotation of liquid crystal molecules is overcome. In addition, by using binary bit shifting and look-up table to selectively adjust the pixel values of all the image regions, the speed of processing the pixel values of the image regions and the overall performance of the LCD are improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A liquid crystal display comprising:
a scaler module, configured for providing multiple images, the multiple images comprising a first image, the first image comprising at least one image region having multiple pixel values and a backlight brightness parameter;
a buffer,
a field-programmable gate array module, comprising:
a regional peak detector, configured for detecting a maximum pixel value in the multiple pixel values of the image region and sending the maximum pixel value to the buffer,
a backlight control unit, configured for receiving the backlight brightness parameter of the image region, retrieving the maximum pixel value from the buffer and selectively adjusting the backlight brightness parameter of the image region according to the maximum pixel value, and
a pixel value control unit, configured for receiving the multiple pixel values of the image region, retrieving the maximum pixel value from the buffer and selectively shifting binary bits of each pixel value of the image region by at least one bit according to the maximum pixel value;
a backlight module, comprising at least a backlight source and being configured for receiving an adjusted backlight brightness parameter from the backlight control unit and controlling the backlight brightness of the backlight source according to the brightness parameter; and
a liquid crystal display module, comprising multiple pixels with liquid crystal molecules respectively, configured for receiving the adjusted multiple pixel values from the pixel value control unit and controlling an orientation of the liquid crystal molecules at the multiple pixels of the liquid crystal display module according to the adjusted multiple pixel values.

2. The liquid crystal display of claim 1, wherein the field-programmable gate array module is electrically connected with the scaler module and the liquid crystal display module through two low voltage differential signaling interfaces, respectively.

3. The liquid crystal display of claim 1, wherein the field-programmable gate array module further comprises a dynamic random access memory controller, the dynamic random access memory controller being electrically coupled to the buffer.

4. The liquid crystal display of claim 1, wherein the buffer comprises a first memory region and a second memory region, the first memory region being configured for storing the maximum pixel values in the group of pixels that have been detected by the regional peak detector, the second memory region being configured for storing the maximum pixel values in all of the pixels of the first image.

5. The liquid crystal display of claim 1, wherein the pixel value control unit is selectively configured for adjusting each pixel value in the image region by using a look-up table.

6. The liquid crystal display of claim 5, wherein the backlight control unit is configured for selectively adjusting the backlight brightness parameter of the image region by a ratio, the ratio being (1/2^{N}), N being the number of bits by which the binary backlight brightness parameter is left shifted.

7. The liquid crystal display of claim 1, wherein there are a plurality of image regions in the first image and a plurality of backlight sources in the backlight module, and a number of the image regions in the first image is equal to that of the backlight sources in the backlight module.

8. The liquid crystal display of claim 1, wherein the images further comprise a second image different from the first image, the first image being displayed before the second image, and the FPGA module is configured for using the maximum pixels values of the first image in adjusting the second image.

9. A method for adjusting backlight brightness of a liquid crystal display, comprising:
providing multiple images, the multiple images including a first image, the first image including at least an image region having multiple pixel values and a backlight brightness parameter;
detecting a maximum pixel value in the multiple pixel values of the image region,
selectively adjusting the backlight brightness parameter of the image region according to the maximum pixel value;
shifting binary bits of each pixel value of the image region by at least one bit according to the maximum pixel value selectively.

10. The method of claim 9, wherein according to the maximum pixel value the binary bits of each pixel value of the image region are selectively shifted by at least one bit by using a look-up table.

11. The method of claim 10, wherein in the step of selectively adjusting the backlight brightness parameter of the image region, the backlight brightness parameter of the image region is selectively adjusted by a ratio, the ratio being (1/2^{N}), N being the number of bits by which the binary backlight brightness parameter is left shifted.

12. The method of claim 9, wherein before selectively adjusting the backlight brightness parameter and the pixel values, storing the maximum pixel values of the image region that have been detected in a first memory region.

13. The method of claim 9, wherein the images further comprise a second image different from the first image, the first image being displayed before the second image, and the maximum pixel values of the first image is used in selectively adjusting the second image.

14. A method for adjusting backlight brightness of a liquid crystal display, comprising:
providing multiple images, the multiple images including a first image, the first image including at least an image region having multiple pixel values and a backlight brightness parameter;
detecting the multiple pixel values of the image region so as to generate a reference value,
selectively adjusting the backlight brightness parameter of whole image region according to the reference value;
selectively shifting binary bits of each pixel value of the image region by at least one bit according to the reference value so as to adjust each pixel value in the image region.

15. The method of claim 14, wherein the reference value is selected from the group consisting of a mode, a median and a mean of the pixel values in the image region.

16. The method of claim 14, wherein the pixel values of the image region are adjusted by using a look-up table.
